(19) United States
(12) Patent Application Publication
(10) Pub. No.: US 2013/0100703 A1
(43) Pub. Date: Apr. 25, 2013

(54) THERMOFORMING METHOD AND PLATE ASSEMBLY THEREOF

(71) Applicants: Hsueh-Tsu CHANG, Taipei City (TW); Yuan-Li CHUANG, New Taipei City (TW)

(72) Inventors: Hsueh-Tsu CHANG, Taipei City (TW); Yuan-Li CHUANG, New Taipei City (TW)

(21) Appl. No.: 13/409,614

(22) Filed: Mar. 1, 2012

(30) Foreign Application Priority Data
Oct. 25, 2011 (TW) 100138750

(51) Int. Cl. F21V 7/00; F21V 8/00; B29C 51/14

(52) U.S. Cl. 362/623; 156/219; 362/615; 362/627

(57) ABSTRACT

The present invention discloses a thermoforming method and a plate assembly thereof. The thermoforming method applicable for manufacturing a plate assembly having a first plate and a second plate comprises the steps of disposing the second plate on a lamination surface of the first plate; putting the first plate and the second plate into a first mold and a second mold respectively; heating and pressing the first mold and the second mold to deform any one of the lamination surfaces of the first plate and the second plate in order to laminate the first plate and the second plate; and opening the first mold and the second mold to remove the plate assembly. The first plate can be a light guide plate, and the second plate can be a reflector.

### CROSS-REFERENCE TO RELATED APPLICATION

This application claims the benefit of Taiwan Patent Application No. 100138750, filed on Oct. 25, 2011, in the Taiwan Intellectual Property Office, the disclosure of which is incorporated herein in its entirety by reference.

### BACKGROUND OF THE INVENTION

1. Field of the Invention

The present invention relates to a thermoforming method and a plate assembly system therefore, in particular to the thermoforming method and plate assembly that adopt an improved manufacturing process to laminate a light guide plate with a reflector and simplify the manufacturing procedure.

2. Description of Related Art

In general, a backlight module as shown in FIG. 1 comprises a light source 90, a reflector 91, a light guide plate 92, a diffusion sheet 93 and a prism sheet 94. The basic principle of operation of the backlight module as shown in FIG. 2 comprises the following steps:

S1: Convert the light source into a plane light source by the light guide plate.

S2: Use the reflector installed at the bottom of the light guide plate to reflect a light exited from the light guide plate into the interior of the light guide plate.

S3: Use the diffusion sheet to diffuse the light uniformly and conceal the flaw of the light exited from the light guide plate.

S4: Concentrate the light by the prism sheet to enhance the brightness of the backlight module.

In the prior art, the reflector is attached onto the light guide plate by manufacturing the light guide plate and the reflector, and then laminating them into an assembly manually. Therefore, the lamination process incurs more manufacturing steps and higher labor cost, and the manual lamination may increase the defective rate.

To cope with the advanced technology and the optical requirements, the surface for laminating the light guide plate and the reflector is not necessary a planar surface. Obviously, the manual lamination method no longer can achieve the effect of laminating the reflector onto the light guide plate completely, and thus limiting the development and optical design of the backlight module.

Therefore, it is an urgent and important subject for manufacturers and designers to design a thermoforming method and develop a plate assembly to overcome the problems of the prior art.

### SUMMARY OF THE INVENTION

In view of the shortcomings of the prior art, it is a primary objective of the present invention to provide a thermoforming method and a plate assembly thereof to overcome the problems of failing to laminate the light guide plate successfully and having a complicated manufacturing procedure of the plate assembly.

To achieve the aforementioned objective, the present invention provides a thermoforming method applicable for manufacturing a plate assembly, and the plate assembly includes a first plate and a second plate, and the thermoforming method comprises the steps of disposing the second plate on a lamination surface of the first plate; putting the first plate and the second plate into a first mold and a second mold respectively; heating the first mold and the second mold to deform any one of the lamination surfaces of the first plate and the second plate to laminate the first plate and the second plate; pressing the first mold and the second mold to laminate the first plate and the second plate; and opening the first mold and the second mold to remove the plate assembly; wherein the second plate covers at least a portion of the surrounding area of the first plate, and the first plate has an optical pattern formed on a surface of the first plate.

Wherein, the method further comprises the steps of heating the first mold and the second mold to a predetermined temperature; and providing a strain pressure to press the first mold and the second mold, so as to produce a plastic deformation of the first plate or the second plate to seal the lamination surface.

Wherein, the method further comprises the step of providing the strain pressure to press the first plate and the second plate, so as to suppress a flash formed by the first plate or the second plate.

Wherein, the method further comprises the step of disposing a sticky material onto a surface of the second plate.

Wherein, the method further comprises the step of disposing a solid sticky material or a liquid sticky material onto a surface of the second plate.

Wherein, the first plate is a light guide plate, and the second plate is a reflector.

To achieve the aforementioned objective, the present invention further provides a thermoforming method applicable for manufacturing a plate assembly, and the plate assembly includes a first plate and a second plate, and the thermoforming method comprises the steps of disposing a lamination surface of the first plate on the second plate; putting the first plate and the second plate into a first mold having a first-surface structure and a second mold having a second-surface structure respectively; heating the first mold and the second mold to deform any one of the lamination surfaces of the first plate and the second plate; pressing the first mold and having the first-surface structure and the second mold having the second-surface structure to laminate the first plate and the second plate, and form the plate assembly having the first-surface structure and the second-surface structure; and opening the first mold and the second mold to remove the plate assembly; wherein, the second plate covers at least a portion of the surrounding area of the first plate.

Wherein, the method further comprises the steps of heating the first mold having the first-surface structure and the second mold having the second-surface structure to a predetermined temperature; and providing a strain pressure to press the first mold having the first-surface structure and the second mold having the second-surface structure, so as to produce a plastic deformation of the first plate or the second plate to seal the lamination surface.

To achieve the aforementioned objective, the present invention further provides a plate assembly, and the plate assembly includes a first plate and a second plate, and the second plate covers at least a portion of the surrounding area of the first plate, and the plate assembly has a first-surface structure and a second-surface structure disposed on surfaces of the plate assembly.

Wherein, the second-plate surface and the first-plate surface corresponding to the second-plate surface have a sticky material for laminating the first plate and the second plate.

In summation of the description above, the thermoforming method and the plate assembly of the present invention can overcome the complicated manufacturing procedure and the high labor cost of the conventional method, so as to improve the yield rate. In addition, when a pattern is pressed and printed onto a surface of the light guide plate, a uniform pressure is applied to complete laminating the light guide plate and the reflector, and suppress the production of a flash. The invention not only enhances the manufacturing process of laminating the light guide plate and the reflector, but also improves the effecting of laminating the reflector on a different shaped surface, so as to simplify the manufacturing procedure and improve the yield rate.

The technical characteristics of the present invention will become apparent with the detailed description of the preferred embodiments accompanied with the illustration of related drawings as follows.

### BRIEF DESCRIPTION OF THE DRAWINGS

FIG. 1 is a schematic view of a conventional backlight module;

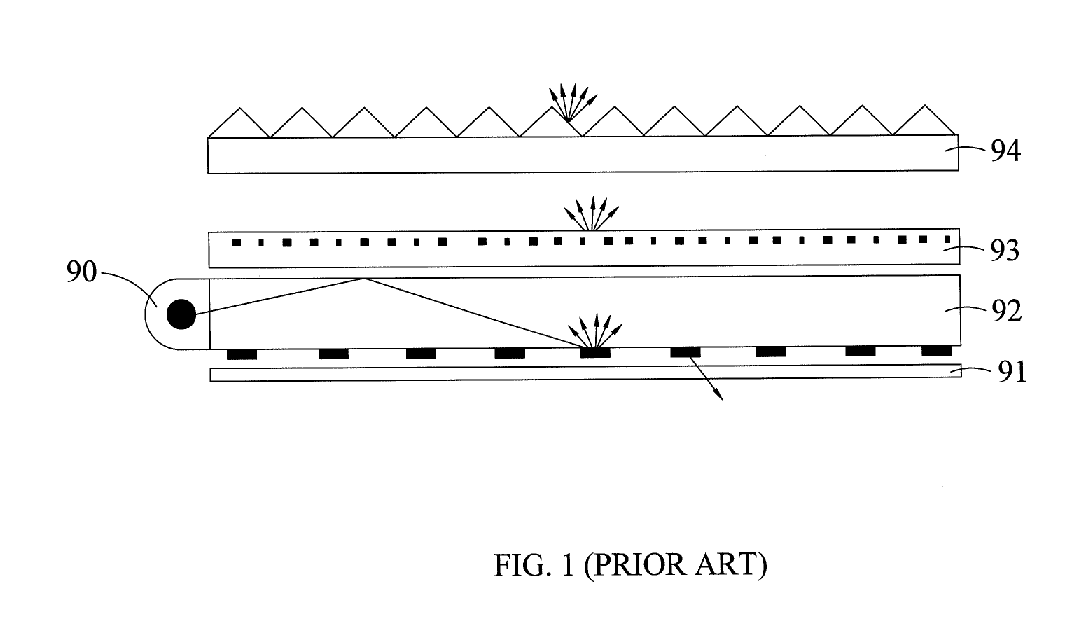

FIG. 2 is a flow chart of the basic operating principle of a conventional backlight module;

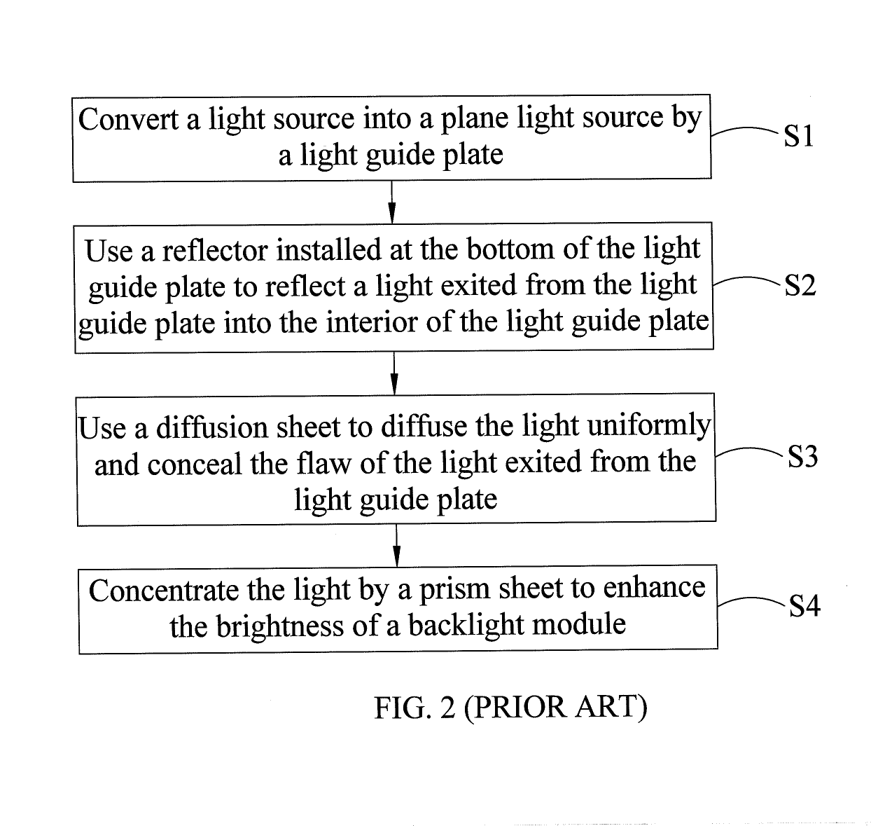

FIG. 3 is a schematic view of a thermoforming method in accordance with a first preferred embodiment of the present invention;

FIG. 4 is a schematic view of a plate assembly in accordance with the first preferred embodiment of the present invention;

FIG. 5 is a schematic view of a thermoforming method in accordance with a second preferred embodiment of the present invention; and

FIG. 6 is a schematic view of a plate assembly in accordance with the second preferred embodiment of the present invention.

### DESCRIPTION OF THE PREFERRED EMBODIMENTS

The technical characteristics of the present invention will become apparent with the detailed description of the preferred embodiments accompanied with the illustration of related drawings as follows. It is noteworthy to point out that the drawings are provided for the purpose of illustrating the present invention, but they are not necessarily drawn according to the actual scale, or are intended for limiting the scope of the invention.

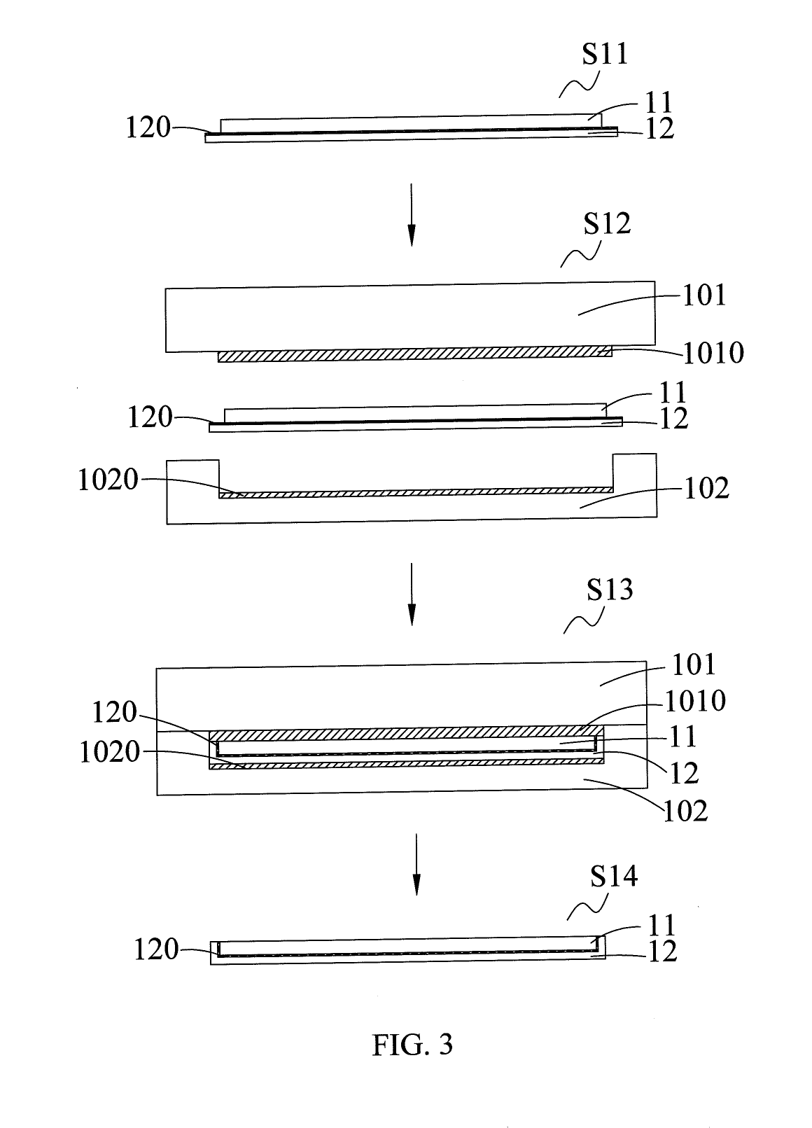

With reference to FIG. 3 for a schematic view of a thermoforming method in accordance with a first preferred embodiment of the present invention, the thermoforming method is applicable for manufacturing a plate assembly, and the plate assembly includes a first plate 11 and a second plate 12. In this preferred embodiment, the first plate 11 can be a light guide plate made of a thermoplastic material, and the second plate 12 can be a reflector made of a thermoplastic material.

The material used for manufacturing the first plate 11 can be polymethylmethacrylate (PMMA), cycio olefins polymer (COP) or polycarbonate (PC), and these materials can be used for manufacturing the light guide plate. The material used for manufacturing the second plate 1212 can be polyethylene terephthalate (PET). The thermoforming method of the present invention comprises the following steps:

S11: Dispose a lamination surface of the first plate 11 onto the second plate 12, and the second plate 12 is disposed at a position corresponding to the first plate 11.

S12: Put the first plate 11 and the second plate 12 into a first mold 101 and a second mold 102 respectively.

S13: Uniformly heat and press the first mold 101 and the second mold 102 to deform any one of the lamination surfaces of the first plate 11 and the second plate 12 to laminate the first plate 11 and the second plate 12. It is noteworthy to point out that the plastic deformation of the first plate 11 or the second plate 12 occurs when they are heated to a predetermined temperature or a strain pressure is exerted to press the first plate 11 and the second plate 12, so that a secured lamination can be achieved. In the meantime, the strain pressure can be adjusted to suppress a flash formed by the first plate 11 or the second plate 12, when the first plate 11 and the second plate 12 are pressed. It is worthy to mention that the sticky material 120 is disposed on a surface of the second plate 12, wherein the sticky material 120 can be a solid sticky material or a liquid sticky material used for enhancing the adhesion between the first plate 11 and the second plate 12.

S14: Open the first mold 101 and the second mold 102 to remove the plate assembly.

In the aforementioned steps S11 to S14, the first plate 11 is laminated with the second plate 12, and the second plate 12 covers at least a portion of the surrounding area of the first plate 11, and an optical pattern can be formed on a surface of the first plate 11.

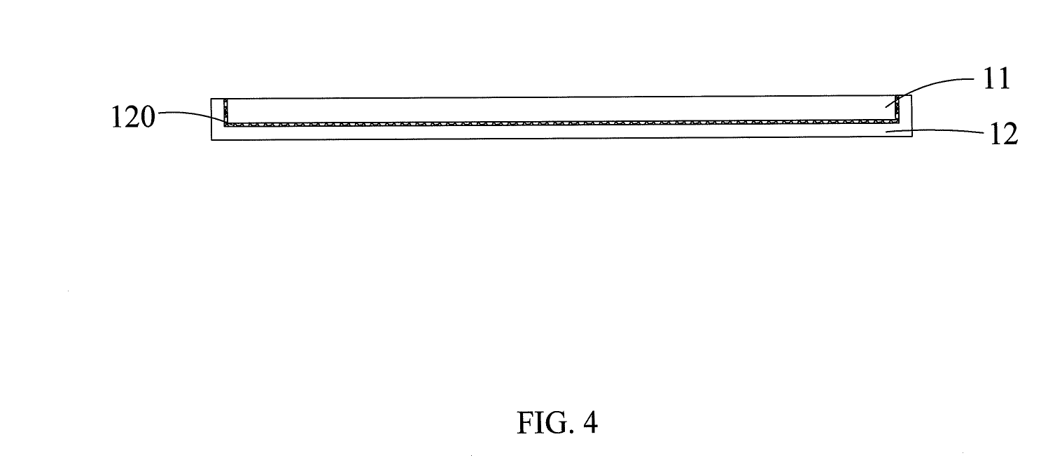

With reference to FIG. 4 for a schematic view of a plate assembly in accordance with the first preferred embodiment of the present invention, the plate assembly can be manufactured by a thermoforming method, and the plate assembly includes a first plate 11 and a second plate 12. The first plate 11 can be a light guide plate made of a thermoplastic material and the second plate 12 can be a reflector made of a thermoplastic material. The material used for manufacturing the first plate 11 can be polymethylmethacrylate (PMMA), cycio olefins polymer (COP) or polycarbonate (PC), and these materials can be used for manufacturing the light guide plate. The material used for manufacturing the second plate 1212 can be polyethylene terephthalate (PET).

It is worthy to mention that the second plate 12 covers at least a portion of the surrounding area of the first plate 11, and the sticky material 120 is disposed on a surface of the second plate 12 and a surface of the first plate 11 corresponding to the surface of the second plate 12 for laminating the first plate 11 and the second plate 12.

Based on the first preferred embodiment, the present invention further provides a second preferred embodiment for further illustrating the invention.

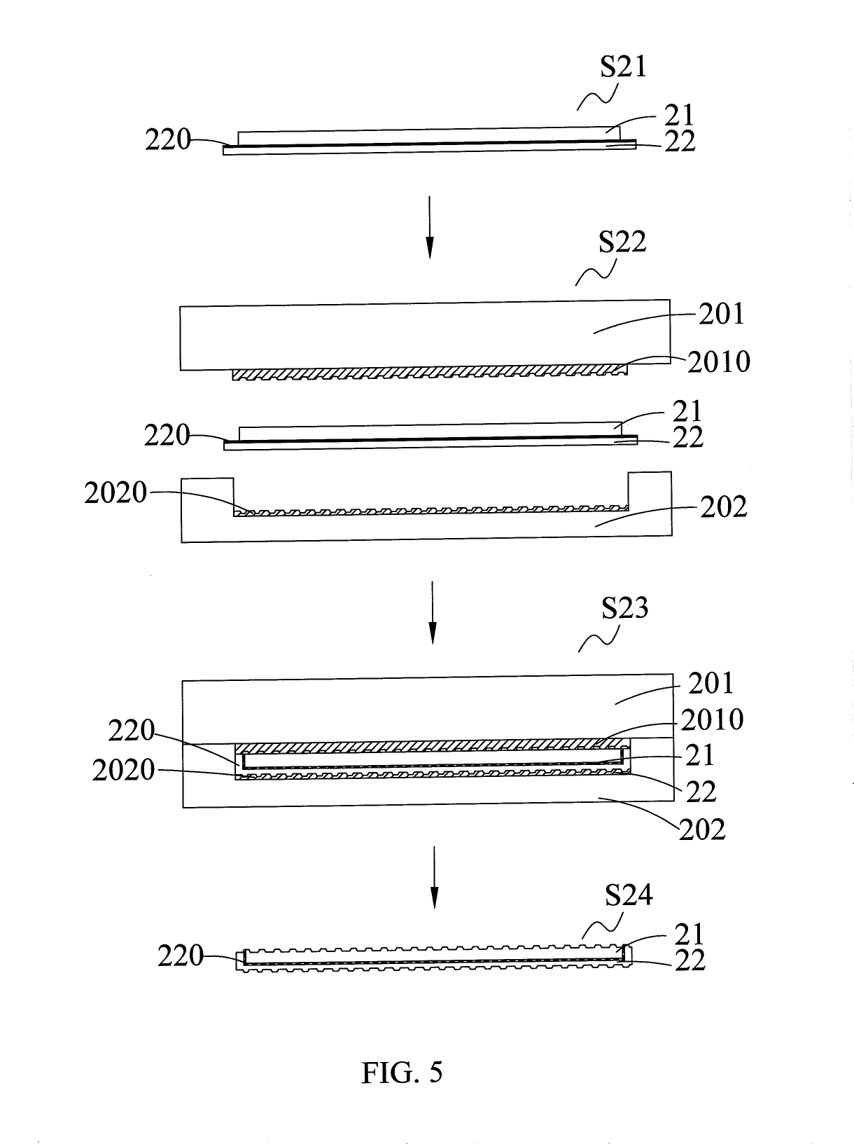

With reference to FIG. 5 for a schematic view of a thermoforming method in accordance with the second preferred embodiment of the present invention, the thermoforming method is applicable for manufacturing a plate assembly, and the plate assembly comprises a first plate 21 and a second plate 22. In this preferred embodiment, the first plate 21 can be a light guide plate made of a thermoplastic material, and the second plate 22 can be a reflector made of a thermoplastic material. The material used for manufacturing the first plate 21 can be polymethylmethacrylate (PMMA), cycio olefins polymer (COP) or polycarbonate (PC), and these materials can be used for manufacturing the light guide plate. The material used for manufacturing the second plate 1212 can be polyethylene terephthalate (PET). The thermoforming method of the present invention further comprises the following steps:

S21: Dispose a lamination surface of the first plate 21 on the second plate 22, wherein the second plate 22 can be disposed at a position corresponding to the first plate 21.

S22: Put the first plate 21 and the second plate 22 into a first mold 201 having a first-surface structure 2010 and a second mold 202 having a second-surface structure 2020.

S23: Uniformly heat and press the first mold 201 having the first-surface structure 2010 and the second mold 202 having the second-surface structure 2020 to laminate the first plate 21 and the second plate 22, so as to form a plate assembly having the first-surface structure 2010 and the second-surface structure 2020. The heating and pressing can deform any one of the lamination surfaces of the first plate 21 and the second plate 22, wherein the plates 21 22 are heated to a predetermined temperature or a strain pressure is applied to press the first plate 21 and the second plate 22 to produce a plastic deformation of the first plate 21 or the second plate 22, so as to achieve a secured lamination between the plates 21, 22. In the meantime, when the first plate 21 and the second plate 22 are pressed, the strain pressure can be adjusted to prevent a flash formed by the first plate 21 or the second plate 22. It is noteworthy to mention that a sticky material 220 can be disposed on a surface of the second plate 22, wherein the sticky material 220 can be a solid sticky material or a liquid sticky material for enhancing the lamination of the first plate 21 and the second plate 22.

It is noteworthy to point out that the lamination surfaces of the first mold 201 and the second mold 202 have a first-surface structure 2010 and a second-surface structure 2020 respectively, such that when the first mold 201 and the second mold 202 press the first plate 21 and the second plate 22, the surfaces of the first plate 21 and the second plate 22 have the first-surface structure 2010 and the second-surface structure 2020 respectively.

S24: Open the first mold 201 and the second mold 202 to remove the plate assembly.

In the aforementioned steps S21 to S24, the first plate 21 is laminated with the second plate 22, and the second plate 22 covers at least a portion of the surrounding area of the first plate 21, and the thermoforming method of the present invention can form an optical structure such as a micro-structure pattern onto the light guide plate directly, while completing the lamination of the reflector onto the light guide plate. The method is very convenient and capable of improving the yield rate.

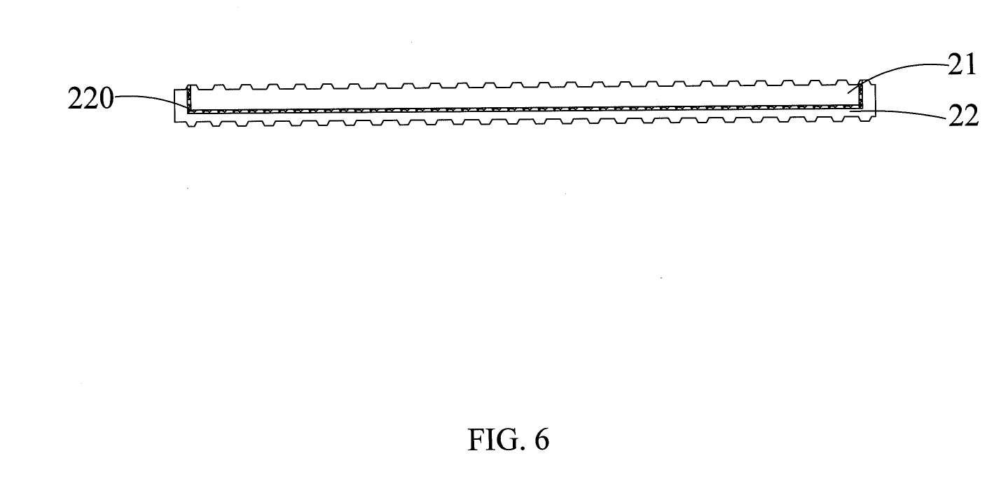

With reference to FIG. 6 for a schematic view of a plate assembly in accordance with the second preferred embodiment of the present invention, the plate assembly can be manufactured by a thermoforming method, and the plate assembly comprises a first plate 21 and a second plate 22. The first plate 21 can be a light guide plate made of a thermoplastic material, and the second plate 22 can be a reflector made of a thermoplastic material. The material used for manufacturing the first plate 21 can be polymethylmethacrylate (PMMA), cycio olefins polymer (COP) or polycarbonate (PC), and these materials can be used for manufacturing the light guide plate. The material used for manufacturing the second plate 2212 can be polyethylene terephthalate (PET). In addition, the second plate 22 can cover at least a portion of the surrounding area of the first plate 21, and a sticky material 220 is disposed on a surface of the second plate 22 and a surface of the first plate 21 corresponding to the surface of the second plate 22 for laminating the first plate 21 and the second plate 22.

More importantly, the plate assembly of the present invention can use the thermoforming method of the present invention to form an optical structure such as a micro-structure pattern on the light guide plate directly, while completing the lamination of the reflector onto the light guide plate. In other words, the thermoforming method of the present invention can simplify the lamination process in the manufacturing procedure of the plate assembly and enhance the yield rate.

The details and embodiments of the plate assembly of the present invention are described in the section of the thermoforming method of the present invention, and thus will not be described again.

It is noteworthy to point out that persons ordinarily skilled in the art should be able to understand that the embodiments with regard to the installation position of each component mentioned in the thermoforming method are provided for illustrating the present invention, but not intended for limiting the scope of the present invention. Persons skilled in the art can combine the aforementioned functional modules into an integrated module or separate each functional unit, depending on the requirements of the design.

In summation of the description above, the thermoforming method and the plate assembly of the present invention have one or more of the following advantages:

(1) The thermoforming method and the plate assembly in accordance with the present invention can overcome the complicated manufacturing procedure and high labor cost of the conventional method, so as to enhance the yield rate of the production.

(2) The thermoforming method of the present invention can laminate the reflector during the heat pressing process.

(3) The thermoforming method of the present invention can provide a uniform pressure to complete laminating the light guide plate and the reflector and suppressing the production of a flash during the process of printing a pattern onto the surface of the light guide plate.

(4) The thermoforming method of the present invention can achieve the effects of improving the process of laminating the light guide plate and the reflector, enhancing the efficiency of laminating the reflector on a different-shaped surface, simplifying the manufacturing procedure, and improving the yield rate.

While the invention has been described by means of specific embodiments, numerous modifications and variations could be made thereto by those skilled in the art without departing from the scope and spirit of the invention set forth in the claims.

What is claimed is:

1. A thermoforming method, applicable for manufacturing a plate assembly, and the plate assembly comprising a first plate and a second plate, and the thermoforming method comprising the steps of:
disposing the second plate on a lamination surface of the first plate;
putting the first plate and the second plate into a first mold and a second mold respectively;
heating the first mold and the second mold to deform any one of the lamination surfaces of the first plate and the second plate;
pressing the first mold and the second mold to laminate the first plate and the second plate; and
opening the first mold and the second mold to remove the plate assembly;
wherein, the second plate covers at least a portion of the surrounding area of the first plate, and the first plate has an optical pattern formed on a surface of the first plate.

2. The thermoforming method of claim 1, further comprising the steps of:
heating the first mold and the second mold to a predetermined temperature; and
providing a strain pressure to press the first mold and the second mold, so as to produce a plastic deformation of the first plate or the second plate to seal the lamination surface.

3. The thermoforming method of claim 2, further comprising the step of providing the strain pressure to press the first plate and the second plate, so as to suppress a flash formed by the first plate or the second plate.

4. The thermoforming method of claim 1, further comprising the step of disposing a sticky material onto a surface of the second plate.

5. The thermoforming method of claim 4, further comprising the step of disposing a solid sticky material or a liquid sticky material onto the surface of the second plate.

6. The thermoforming method of claim 1, wherein the first plate is a light guide plate, and the second plate is a reflector.

7. A thermoforming method, applicable for manufacturing a plate assembly, and the plate assembly comprising a first plate and a second plate, and the thermoforming method comprising the steps of:
disposing a lamination surface of the first plate on the second plate;
putting the first plate and the second plate into a first mold having a first-surface structure and a second mold having a second-surface structure respectively;
heating the first mold and the second mold to deform any one of the lamination surfaces of the first plate and the second plate;
pressing the first mold and having the first-surface structure and the second mold having the second-surface structure to laminate the first plate and the second plate, and form the plate assembly having the first-surface structure and the second-surface structure; and
opening the first mold and the second mold to remove the plate assembly;
wherein, the second plate covers at least a portion of the surrounding area of the first plate.

8. The thermoforming method of claim 7, further comprising the steps of:
heating the first mold having the first-surface structure and the second mold having the second-surface structure to a predetermined temperature; and
providing a strain pressure to press the first mold having the first-surface structure and the second mold having the second-surface structure, so as to produce a plastic deformation of the first plate or the second plate to seal the lamination surface.

9. The thermoforming method of claim 8, further comprising the step of providing the strain pressure to laminate the first plate and the second plate to suppress a flash formed by the first plate or the second plate.

10. The thermoforming method of claim 7, further comprising the step of disposing a sticky material onto a surface of the second plate.

11. The thermoforming method of claim 10, further comprising the step of disposing a solid sticky material or a liquid sticky material onto the surface of the second plate.

12. The thermoforming method of claim 7, wherein the first plate is a light guide plate, and the second plate is a reflector.

13. A plate assembly, comprising a first plate and a second plate, and the second plate covering at least a portion of the surrounding area of the first plate, and the plate assembly has a first-surface structure and a second-surface structure disposed on surfaces of the plate assembly.

14. The plate assembly of claim 13, wherein the second-plate surface and the first-plate surface corresponding to the second-plate surface have a sticky material for laminating the first plate and the second plate.

15. The plate assembly of claim 13, wherein the first plate is a light guide plate, and the second plate is a reflector.
